(19) United States
(12) Patent Application Publication
(10) Pub. No.: US 2004/0112661 A1
(43) Pub. Date: Jun. 17, 2004

(54) Vehicle with retractable wheel

(76) Inventor: David Albert Cyril Royle, Co. Durham (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/476,474

(22) PCT Filed: Apr. 29, 2002
(86) PCT No.: PCT/GB02/01961

(30) Foreign Application Priority Data
May 1, 2001 (GB) 0110638.4

(51) Int. Cl. B62D 61/12

(52) U.S. Cl. 180/209; 280/43

(57) ABSTRACT

A vehicle having a wheel which is movable between a lower position and a raised position by a wheel retraction and lowering mechanism is described, the mechanism including a guide to determine the path of the wheel during retraction, said guide being in the form of a pillar, and characterised in that a lower portion (c;16) of which is slidable relative to an upper portion (B;14) whereby the length of the pillar is less when the wheel is in its retracted position than when it is in its lowered position.

### FIELD OF THE INVENTION

The invention relates to vehicles with retractable wheels, especially, but not exclusively, vehicles in the form of amphibious craft. In particular, the invention concerns the wheel retraction and lowering mechanisms and suspension assemblies of such vehicles.

### BACKGROUND TO THE INVENTION

Some known amphibious vehicles have wheels which are movable between a lower position in which they engage the ground and by means of which the vehicle is driven on land, and a raised position in which they are stored while they are not in use during water-borne operation. WO 93/15923A discloses a vehicle with a retractable wheel in which the wheel is supported in at least its lower position. The retraction mechanism comprises a support element connected to the wheel via a coupling on the element. Means are provided for moving the support element in a path encompassing a highest position of the coupling, a lowest position of the coupling, and an upward return beyond the lowest position. The means for moving the element comprises a rotary member and the mechanism includes an abutment disposed in the path of the element to limit the upward return of the element.

As illustrated and described in WO 93/15923A, the wheel retraction assembly is in the form of two pairs of sprockets about which are mounted a pair of chains. The sprocket pairs are locked together on respective common shafts which are in turn supported for rotation on a frame, the frame having a pair of side walls between which one run of each chain extends. The other run of each chain extends outside the walls of the frame and together these runs carry a rod to which is connected the coupling element which in turn is connected to the wheel. The rod extends between the chain runs and outwardly on each side therefrom. The coupling includes a pair of springs and dampers, each member of the pair being connected at one end to a respective arm of the rod and at the other end to a further rod which in turn is connected to a collar carrier carrying a collar linked to the wheel and being movable up and down a pillar which acts as a guide to determine the path and movement of the wheel.

The arrangement described in WO 93/15923A is effective in providing a safety stop for the wheel mechanism to support the wheels, particularly in the lower position when carrying the vehicle weight. However, this wheel retraction mechanism whilst allowing the wheel to be retracted to a position clear of the water when the wheel is not in use, the lower end of the pillar can extend into the water creating drag and is thus not hydrodynamically efficient.

### STATEMENT OF INVENTION

According to the present invention, there is provided a vehicle having a wheel which is movable between a lower position and a raised position by a wheel retraction and lowering mechanism, the mechanism including a guide to determine the path of the wheel during retraction, said guide being in the form of a pillar, and characterised in that a lower portion of which is slidable relative to an upper portion whereby the length of the pillar is less when the wheel is in its retracted position than when it is in its lowered position.

The present invention also provides a vehicle having a wheel which is movable between a lower position and a raised position by a wheel retraction mechanism, the wheel retraction mechanism including a transmission linked to the wheel via a suspension device, the transmission being in the form of a continuous flexible element located between the walls of a transmission carrier and the suspension device extending from a position either between said walls or to one or both sides of the walls to the wheel via a coupling. The flexible transmission means may be belts of which various types may be suitable, however, in a preferred embodiment, chains supported on and driven by rotatable sprockets may be employed.

The suspension device may be a shock absorber and/or a spring. In a preferred embodiment, a shock absorber and a spring may be combined together such as in a coaxial manner.

The raising and lowering mechanism may also include means to enable the mechanism to be locked in the raised and lowered positions so that there is no danger of the mechanism accidentally becoming dislodged when in the lowered, road-going configuration, for example, or suddenly descending when in water-borne mode due to adverse road or water conditions.

The wheel raising and lowering mechanism may be for wheels with steering means connected to the mechanism or for non-steered wheels, for example.

### DETAILED DESCRIPTION OF THE DRAWINGS

The present invention will now be described, by way of example only, with reference to the accompanying drawings, of which:

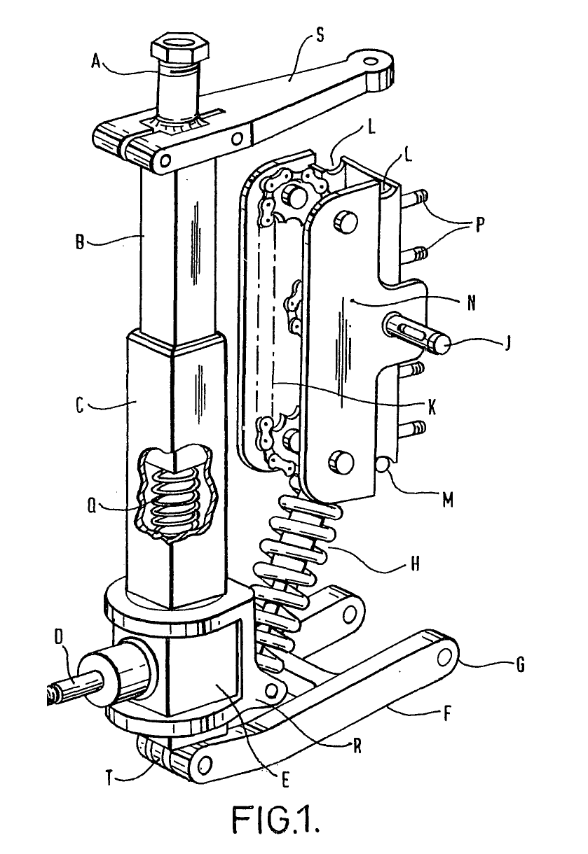

FIG. 1 shows a perspective view of a first embodiment of a wheel mechanism of an amphibious craft in accordance with the present invention;

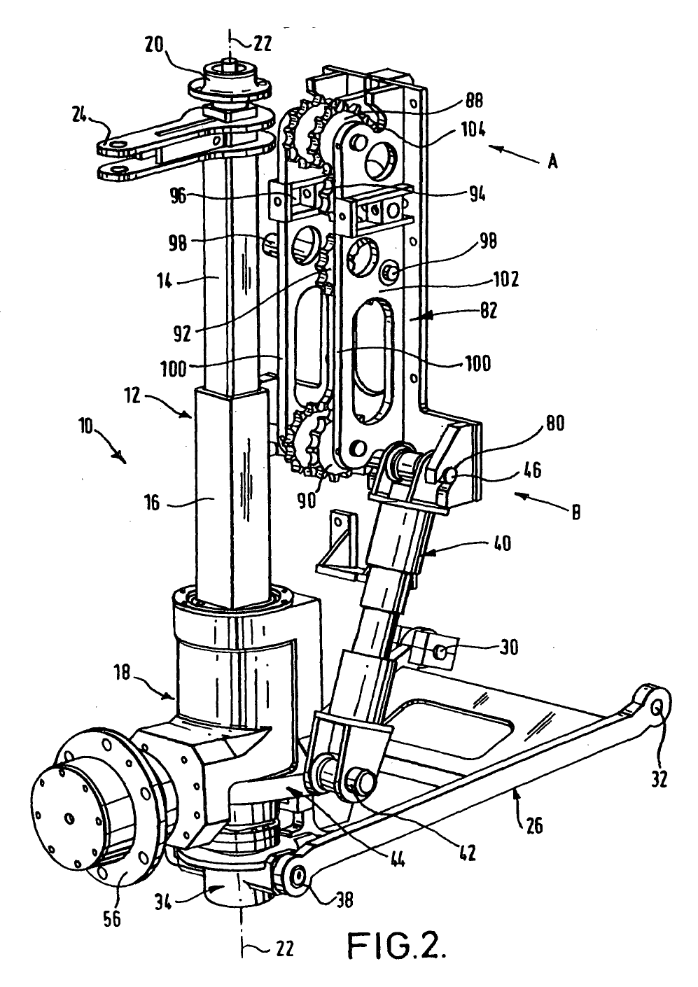

FIG. 2 shows a perspective view of a second embodiment of a wheel raising and lowering mechanism according to the present invention but with some components omitted for the sake of clarity

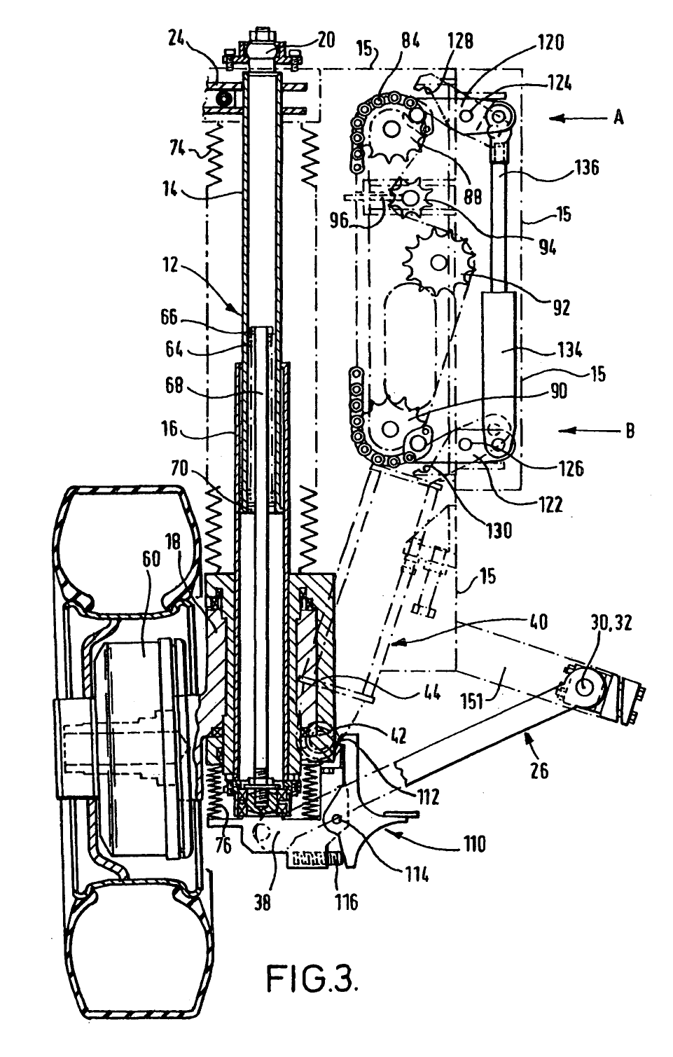

FIG. 3 shows a front view in cross section of the mechanism of FIG. 2 with the wheel in the lowered position;

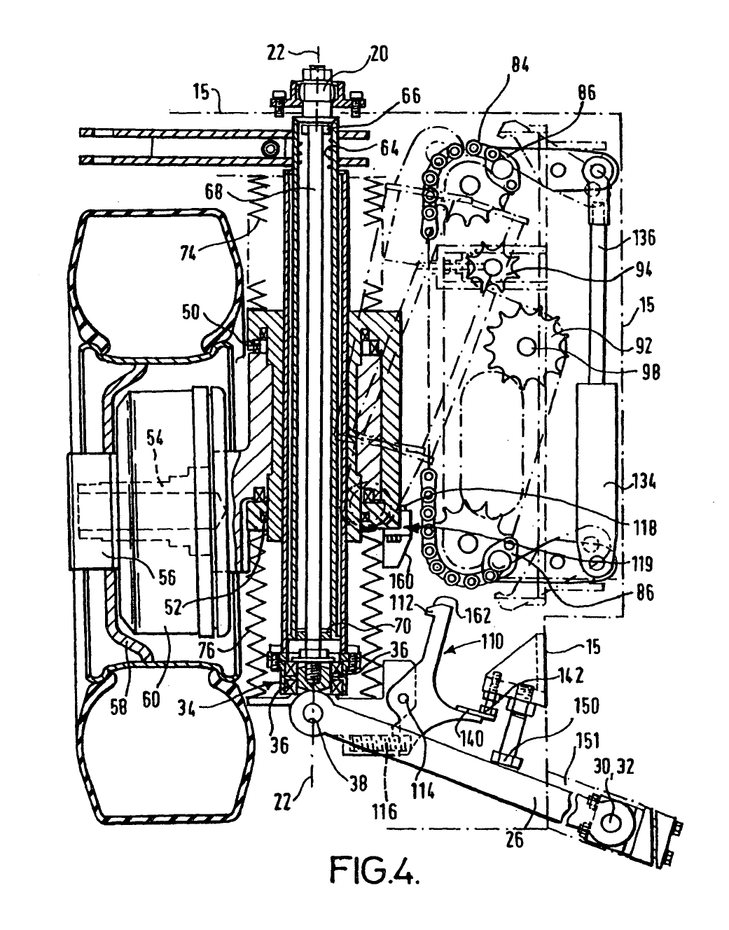

FIG. 4 shows a similar view to FIG. 3 but with the wheel in the raised position; and

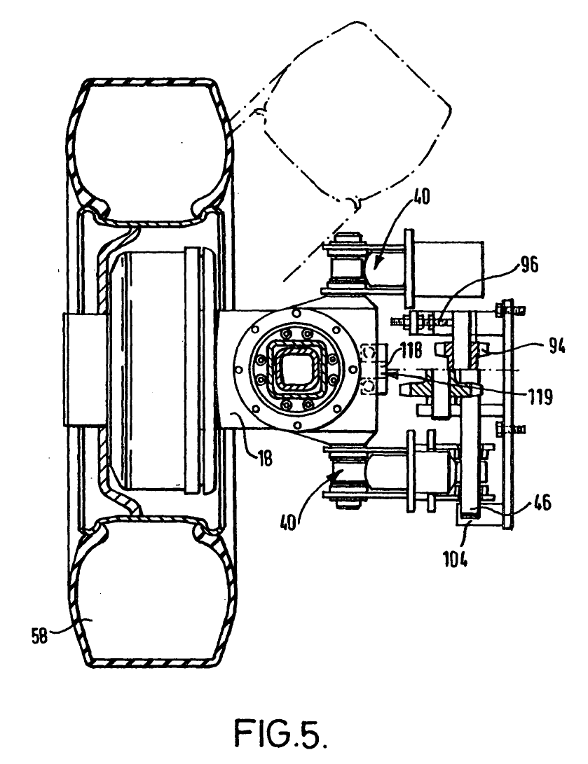

FIG. 5 shows a top plan view partially in cross section of the embodiment of FIGS. 2 to 4.

### DESCRIPTION OF THE EMBODIMENTS

Referring now to FIG. 1 and where the wheel retraction mechanism shown may be used in connection with an amphibious craft such as that partly shown in FIG. 1 of WO 93/15923A, the wheel retraction mechanism shown in the accompanying drawing replacing that of WO 93/15923A.

In this case the wheel support mechanism includes a pillar which comprises a lower section C mounted for sliding movement over an upper section B. The upper section B of the pillar is pivotally anchored at its upper end at A and steering arm S is linked to the steering mechanism and a driver's steering wheel (both not shown). Lower section C of the pillar moves up and down the upper section B as a result of road movement. Furthermore, lower section C is designed to slide partially or fully up to the top of upper section B when the wheel and suspension are fully retracted.

A spring Q extends within the hollow pillar sections B and C from top pivot A to a lower pivot T associated with bottom suspension arm F (referred to below). Spring Q provides sufficient force to counter-balance the weight of suspension wishbone arm F and pillar C which is pivotally connected at T and maintaining contact with the carriage frame R (referred to below) as it rises and falls with suspension movement when the retraction mechanism is operated.

A collar E is fitted on lower section C of the pillar to be slidable up and down and rotatable with the pillar. In this case the section of the pillar and that of the collar are both square. However, the shape is not important so long as the sections co-operate to prevent relative rotation between the pillar and the collar.

The road wheel (not shown) is fitted on the wheel hub D which is mounted directly onto the collar E.

A collar carrier or carriage frame R transfers the load from the road wheel and the collar E via the suspension unit H and onto the chassis or body (not shown). The carriage frame R also allows movement of the collar E up and down section C of the pillar. Carriage frame R is connected to the lower end of a spring and damper arrangement H, this arrangement H being located on the opposite side of pillar section C to the road wheel hub D. It is to be noted that the present wheel retraction mechanism has only a single spring and damper arrangement as compared to the two arrangements of the mechanism shown in WO 93/154923A.

The spring and damper arrangement H provides a suspension device or shock absorber with a compression spring fitted around a piston and damper in the usual way. The upper end of the arrangement is hinged to a support arrangement comprising a rod M mounted on and fixed to travel with a double chain K (one chain only being shown in the drawing). The double chain K is a strong continuous chain mounted about three pairs of rotary members in the form of sprockets. The sprockets forming each of the sprocket pairs are locked together on respective common shafts to maintain parallel motion of the chains and thereby prevent tilting of the rod to which the mechanism H is attached. The shafts are supported for rotation on a frame or chain carrier N which is bolted to the chassis/hull of the vehicle by bolts P. Chain carrier N includes opposed side walls which are connected together by means of a rear wall through which bolts P extend. Shaft J is a drive shaft which extends outwardly from one of the side walls of chain carrier N and is driven either clockwise or anti-clockwise by a rotary motor such as an electric motor (not shown) causing the rod M, to which arrangement H is attached, to move up or down in a path determined by the movement of the chains K and the sprockets. This in turn lifts or lowers the suspension device H. The manner of locking of the wheel in its upper and lower positions is similar to that described in WO 93/15923A. However, in this case the cross-bar M is now supported on upper rests L (and corresponding lower rests) which are similar to those shown in FIG. 2 of WO 93/15923A except that they are inset.

Lower section C of the pillar is pivotally mounted to the chassis/hull via a bottom wishbone-shaped suspension arm F which is hinged to the chassis/hull at G. Suspension arm F moves up and down with the road wheel along with the lower pillar member C.

As illustrated in the accompanying drawing, the wheel (not shown) is in its lowered position for road use. To retract the wheel when the vehicle is on water, the operator causes the motor to turn the drive shaft J and move the sprockets and chains in a clockwise direction. The cross-bar M is thereby carried from the position shown in the accompanying drawing initially downwardly and then upwardly along the length of the chain carrier N. There is then a further downward movement until cross-bar M engages in inset rests L.

During this movement the suspension arrangement H causes the carriage frame R to rise to its maximum height carrying with it the collar E, wheel hub D and the road wheel (not shown). At the same time the spring Q maintains an upward force on the wishbone arm F and pillar member C on the carriage frame R and when the pillar C reaches its upper limit, the carriage frame arm R continues to lift by sliding up lower pillar section C, thereby carrying collar E, wheel hub D and the road wheel (not shown) to a position just below steering arm S at the top of the telescoped pillar sections B and C. The wishbone arm F having reached the limit of its arc of movement may not necessarily be able to follow the carriage frame R to the extremity of its upper movement.

The above described wheel retraction mechanism is more compact than that described in WO 93/15923A. Furthermore it is more easily sealed against road dirt and the dirt (flotsam and jetsam) encountered on water. Since the bottom suspension arm and the lower section of the pillar are retracted when the suspension and wheel is raised, less drag is created in the water. Furthermore there is more room to fit planing flaps to give improved craft performance. In addition more ground clearance is provided for the vehicle.

There is less wear on the lower pillar section C and the sliding joint between sections B and C of the pillar can be easily sealed against dirt and abrasive materials to minimise wear from movement of the suspension. In this embodiment, the chains K are incorporated within the space defined by the side walls of the chain carrier N and only a single spring and damper arrangement is required. The drive shaft J is also incorporated into the chain carrier N and furthermore it no longer intrudes into the cabin of the vehicle.

Referring now to FIGS. 2 to 5 which show a second embodiment of a suspension and wheel raising and lowering mechanism according to the present invention and where the same features are denoted by common reference numerals.

The suspension and wheel raising and lowering mechanism 10 shown in FIGS. 2 to 5 is similar in operation to that shown in FIG. 1 but has several additional safety features.

Most of the major components of the suspension system 10 are shown in the perspective view of FIG. 2, however, some essential components are omitted from FIG. 2 (but shown where appropriate in FIGS. 3 to 5) in the interests of clarity. The suspension mechanism includes a main vertical support pillar 12 of generally square cross section comprising an upper member 14 able to slide within a lower pillar member 16 and a lower hub assembly 18 able to slide on the lower pillar member 16. The whole pillar 12 is located on the vehicle hull 15 (indicated by the chain dashed and dotted lines 15 in the region of the recess into which the wheel retracts but also see FIG. 1 of WO93/15923A) at the upper end by a bearing 20 to enable the pillar rotate about its axis 22, control of which rotation is effected by a steering arm 24 which is itself connected to a steering linkage and driver's steering wheel (both not shown). Location of the lower end of the pillar 12 and hub assembly 18 is by a lower suspension wishbone link 26 which is pivotably located at points 30, 32 on the vehicle hull and to a bearing arrangement 34 fixed to the lower end of the lower pillar member 16. The lower bearing arrangement 34 comprises a pair of rolling element bearings 36 to permit rotation of the pillar 12 about its axis 22 and bearings 38 to permit vertical movement of the pillar assembly 12 in response to suspension movements when the vehicle is in road-going mode and when raising or lowering the suspension assembly 10. Suspension springing and shock absorbing is provided by twin coaxial shock absorber/coil spring units 40 (only one of which is shown in FIG. 2 the coil spring also being omitted for clarity) which are located at the lower end by a bearing 42 on a bracket 44 which is associated with the hub member 18 and is able to slide relative to the pillar member 16 when required. The coil spring/damper unit 40 is located at the upper end on a moveable cross shaft 46 which may be rigidly located in either of two extreme positions (A or B) when the suspension is either raised (A) or lowered (B) and which will be described in greater detail below with regard to the raising and lowering of the mechanism. The bracket 44 sustains the suspension loads when the vehicle is in road-going mode. The hub assembly 18 is rotatably located within the bracket 44 by bearings 50, 52 at the upper and lower ends thereof. The hub assembly 18 supports the wheel on a stub axle 54 on which is a rotatably mounted hub 56 to which the road wheel 58 is bolted. A brake unit 60 (which may be a drum or disc brake system) is also incorporated in known manner and which will not be described further.

Within the pillar 12 is a spring 64 which, when the pillar members 14 and 16 are fully extended relative to each other, is compressed to a maximum but without binding. Compression of spring 64 is effected by disposing the spring between two flanges, one of which 66 is held by one end of a rod 68 which is located at its opposite end to the lower end of the lower pillar member 16. The second flange 70 is held in the lower end of the upper pillar member 14 and, as the pillar members 14 and 16 move apart, the spring 64 is compressed. The force exerted by the spring 64 is sufficient cause the two pillar members 14 and 16 to slide into each other when the suspension is being raised for water-borne operation of the vehicle. The pillar 12 and bearing arrangement 34 are protected from dirt and debris by gaiters 74 and 76 which extend and collapse depending on the positions of the suspension components.

The upper ends of the coil spring/shock absorber units 40 are located by the moveable transverse shaft 46. At the lower extreme position “B” the shaft and suspension unit 40 are located in recesses 80 in a chain and sprocket wheel carrier frame 82 which is immovably fixed to the vehicle hull. The recesses 80 have corresponding recesses in the side plates 102 of the chain carrier frame 82 and exist on both sides of the chain carrier frame thus, there are supporting recesses 80 lying either side of each coil spring/shock absorber unit 40 to minimise bending stresses when in the lowered position. At the upper end of the chain carrier frame 82 only recesses 104 are provided in the side plates 102 since only the weight of the suspension in the raised position need be supported when the vehicle is water-borne. The shaft 46 is fixed to endless double carrier chains 84 by means of special chain links 86 having the same pitch as the links of the chains 84. The chains pass around double upper sprockets 88, lower sprockets 90, driving sprockets 92 and adjustable tensioner sprockets 94 (see FIGS. 3 and 4). The tensioner sprocket 94 is adjustable laterally by a tensioning arrangement 96 which is merely present to take up any slack which may develop in the chains 84 and sprockets as a result of wear. The driving sprockets 92 are mounted on a shaft 98 driven by an electric motor (not shown).

When in the fully lowered position a pawl 110 having a locking tooth 112 and pivoted about a fulcrum 114 is resiliently biased by a spring loaded pin 116 to engage an upper edge 118 of a locking and deflector plate 119 fixed to the bracket 44 and maintains the bracket 44, hub assembly 18 and associated parts in engagement with the lower end of the lower pillar 16 and wishbone link 26. Thus, in road-going mode, the bracket and associated parts cannot move up the lower pillar member 16 and is constrained to move in response to bumps in the road and the like with the lower suspension arm 26.

When the suspension system 10 is in either the fully raised (“A”) or fully lowered (“B”) positions. The transverse shaft 46 is locked in position by one of two pawls 120 or 122 depending upon the position. The pawls 120, 122 are pivoted about fulcrums 124, 126, respectively and have recesses 128, 130 which engage with the shaft 46 as appropriate. When the suspension is in the desired position, a pneumatic or hydraulic cylinder 134 and piston 136 are expanded to bring the recesses 128 or 130 into locking engagement with the shaft 46, by rotating the pawls 120, 122 about their pivots 124, 126 so as to prevent the shaft from disengaging from the recesses 80 or 104 by inertia forces, for example, due to adverse road or water conditions.

The actions occurring during raising and lowering of the suspension system 10 will be described below.

Beginning with the configuration shown in FIG. 3 where the suspension is in the fully lowered position: the cylinder/piston unit 134, 136 is contracted so as to remove the pawl 122 from engagement with the shaft 46. Rotation of the shaft 98 in the clockwise direction (looking at FIG. 3) causes the shaft 46 (and upper ends of suspension units 40 to initially descend but then to ascend along the vertical faces 100 of the chain carrier frame 82 side plates 102. As the suspension is raised the upper pillar 14 and lower pillar 16 start to retract into one another assisted by the spring 64 but at this stage the bracket 44 and hub 18 are still in engagement with the lower end of the lower pillar member 16 and wishbone link 26 due to the resiliently biased pawl 110. As the raising operation progresses and the shaft 46 rises along the faces 100 of the chain carrier frame 82, a catch plate 140 on the pawl 110 comes into contact with a fixed but adjustable abutment 142 which serves to rotate the pawl 110 about the fulcrum 114 and move the tooth 112 of the pawl out of engagement with the bracket and deflector plate 119 thus allowing the bracket 44 and hub 18 to slide up along the lower pillar member 16. Shortly after the pawl 110 is disengaged from the bracket 44, the lower suspension arm 26 is brought to rest against a second fixed but adjustable suspension abutment stop 150 which prevents any further movement of the wishbone arm 26 and lower pillar member 16, the wishbone arm now lying in recess 151 in the hull bottom and indicated by the chain dashed and dotted lines. However, the shaft 46 and coil spring shock absorber units 40 continue to rise under the action of the rotating shaft 98 and chains 84, the suspension units 40 drawing the bracket 44 and hub 18 (and, of course the road wheel itself) up the lower pillar member 16 until the shaft 46 is carried over the sprocket 88 to lie in the recess 104 when the suspension system is in its maximum, stable raised position. At this point, the cylinder/piston unit 134, 136 is expanded to bring the pawl 120 into locking engagement with the shaft 46 at position “A”.

Lowering of the suspension system is the reverse of that described above by rotation of the shaft 98 in the anti-clockwise direction (as viewed in FIGS. 3 and 4). However, as the bracket 44 and hub 18 and the arm 26 descend, thus allowing the pawl 110 to move to the left as seen in FIGS. 3 and 4, a lower angled face 160 of the deflector plate moves the pawl 110 to the right by sliding along upper face 162 of the tooth 112 which, when it has passed the edge of top face 118 of the deflector plate 119 and snaps back into locking engagement with the bracket 44 under the action of the spring loaded pin 116.

As with the first embodiment, this second embodiment is also more compact than that shown in WO93/15923A allowing the suspension and wheel and tyre 58 to be raised completely out of the water and enable planing boards or flaps to be fitted over the aperture housing the suspension to enable efficient high speed operation on water unlike prior art amphibious vehicles.

Furthermore, the second embodiment has the pawls 120, 122 which enable the suspension to be locked in either the lowered or raised positions thus increasing safety. The cylinder/piston unit 134, 136 may be activated automatically by appropriate switching/valve means such that from initiating raising or lowering until final locking in the opposite configuration is all carried out in one automated sequence.

The presence of the locking pawl 110 ensuring that the bracket 44 and hub stay in contact with the lower end of the lower pillar member 16 and wishbone link 26 when in the down position also ensures safe and reliable operation with a minimum of wear on the bracket and hub due to unwanted movement of the hub assembly relative to the pillar member 16 during road-going operation.

The configuration of the suspension system according to the present invention makes it suitable for either lightweight amphibious vehicles as with the first embodiment or with heavier vehicles such as buses carrying 30 or more people, for example, as with the second embodiment. The safety features relating to the suspension mechanism being lockable in either the raised or lowered positions by means of the pawls 120, 122 may also be fitted to the first embodiment as may the arrangement with the pawl 110 to lock the bracket 44 and hub 18 in the extreme lowered position relative to the lower pillar member C.

Certain specific features have been mentioned in the examples described above such as an electric motor for driving shaft 98, for example, and hydraulic or pneumatic cylinders for locking activation mechanism 134, 136. However, any suitable equivalent means may be employed for these and other functions.

1. A vehicle having a wheel which is movable between a lower position and a raised position by a wheel retraction and lowering mechanism, the mechanism including a guide to determine the path of the wheel during retraction, said guide being in the form of a pillar, and characterised in that a lower portion (C;16) of which is slidable relative to an upper portion (B;14) whereby the length of the pillar is less when the wheel is in its retracted position (A) than when it is in its lowered position (B).

2. A vehicle according to claim 1 wherein one of said lower or said upper pillar portions is slidable within the other of said portions.

3. A vehicle according to either claim 1 or claim 2 wherein a wheel carrying member (D,E,R;44,18,56) is slidable on the lower pillar portion (C;16).

4. A vehicle according to any one preceding claim wherein an upper end (A;20) of said pillar is located on a hull or chassis of the vehicle.

5. A vehicle according to any one preceding claim wherein said pillar (B,C;14,16) is rotatable about an axis (22) thereof.

6. A vehicle according to claim 5 wherein said pillar has a steering arm (S;24) linked to a steering linkage.

7. A vehicle according to any one preceding claim wherein a lower end of said pillar is pivotably connected to one end of a suspension arm which is pivotably connected at an opposite end thereof to a chassis or hull of said vehicle.

8. A vehicle according to any one preceding claim wherein a suspension unit is operably connected between said pillar and means for raising and lowering of said wheel.

9. A vehicle according to claim 8 wherein said suspension unit includes a shock absorber and/or spring (H;40).

10. A vehicle according to any one preceding claim wherein said wheel raising and lowering means comprises a flexible driving means (K;84).

11. A vehicle according to claim 10 wherein the flexible driving means comprises chains (K;84)

12. A vehicle according to claim 11 wherein said chains are endless chains supported on rotatably supported sprockets (88,90,92).

13. A vehicle according to claim 12 wherein one of said sprockets is a driven sprocket (92).

14. A vehicle according to any one of preceding claims 8 to 13 wherein an upper end of said suspension unit is connected to said flexible driving means and on being raised by said flexible driving means causes said wheel to be raised and said pillar to contract.

15. A vehicle according to claim 14 wherein said wheel carrying member is also able to slide relative to said lower pillar portion.

16. A vehicle according to any one preceding claim wherein said mechanism includes means (120,122, 128,130,134,136) to lock the mechanism in the raised or the lowered positions.

17. A vehicle according to any one preceding claim further including means to lock (110,112,114,118) a wheel carrying member (44,18,56) in the vertical direction relative to said lower pillar portion (16) when said mechanism is in the lowered position.

18. A vehicle according to any one preceding claim wherein the pillar (B,C;12,14,16) is of non-round cross section.

19. A vehicle according to claim 18 wherein the pillar is of rectangular or square cross section.

20. A vehicle according to any one preceding claim wherein retention means (110,118,119) to maintain the wheel carrying assembly (18,44,56) at a lower extremity of said lower pillar member (16) when the wheel is in the fully lowered position are provided.

21. A vehicle according to claim 20 wherein the retention means includes pawl (110) and plate (119).

22. A vehicle according to either claim 20 or 21 wherein said retention means automatically disengages on raising of the road wheel to the retracted position allowing said wheel carrying assembly to slide upwardly relative to said lower pillar member 16.
